(19) United States
(12) Patent Application Publication
(10) Pub. No.: US 2026/0332531 A1
(43) Pub. Date: Oct. 22, 2026

(54) MULTI-MODALITY TRAFFIC INFORMATION REPORTING

(71) Applicant: ZTE Corporation, Shenzhen (CN)

(72) Inventors: Xiubin SHA, Shenzhen (CN); Yuan GAO, Shenzhen (CN); Eswar Kalyan VUTUKURI, Shenzhen (CN)

(21) Appl. No.: 19/718,168

(22) Filed: Jun. 24, 2026

Related U.S. Application Data
(63) Continuation of application No. PCT/CN2024/070493, filed on Jan. 4, 2024.

(51) Int. Cl. H04L 47/24; H04L 69/322

(52) U.S. Cl. CPC H04L 47/24; H04L 69/322

(57) ABSTRACT

Techniques are described for service information reporting. An example wireless communication method includes transmitting, by a communication device, an indication that the communication device is capable of transmitting a report that includes multi-modality information, where the multi-modality information includes information about packet data unit (PDU) sessions, quality of service (QoS) flows and/or sub QoS flows that are related to each other; receiving, in response to transmitting the indication, a message that includes a configuration; and transmitting, in response to receiving the configuration, the report comprising the multi-modality information

### CROSS-REFERENCE TO RELATED APPLICATION

This application is a continuation and claims priority to International Application No. PCT/CN2024/070493, filed on Jan. 4, 2024, the disclosure of which is hereby incorporated by reference herein in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for traffic information reporting to assist a base station to schedule radio resource(s) effectively. For example, traffic information may include extended reality (XR) Multi-modality service information reporting.

A first example wireless communication method includes transmitting, by a communication device, an indication that the communication device is capable of transmitting a report that includes multi-modality information, where the multi-modality information includes information about packet data unit (PDU) sessions, quality of service (QoS) flows and/or sub QoS flows that are related to each other; receiving, in response to transmitting the indication, a message that includes a configuration; and transmitting, in response to receiving the configuration, the report comprising the multi-modality information.

In some embodiments, the configuration includes multi-modality information reporting indication per PDU session, the configuration includes a PDU session identifier (ID), the configuration includes multi-modality information reporting indication per QoS flow or QoS flow identifier (ID) in a PDU session, and/or the configuration includes a multi-modality information reporting prohibit timer. In some embodiments, the report comprising the multi-modality information includes a QoS flow information that include the QoS flows, each QoS flow comprises at least one of a sub QoS flow list, a PDU set dependency indication, a PDU set group information, a PDU set synchronization information and/or a PDU set group delay budget, the sub QoS flow list includes the sub QoS flows, or the report comprising the multi-modality information includes a Multi-modality information indication configured per sub QoS flow.

In some embodiments, each sub QoS flow includes at least one of a sub QoS flow identifier (ID), a sub QoS flow priority, packet delay budget (PDB), packet error rate (PER), PDU set delay budget (PSDB), or PDU set error rate (PSER). In some embodiments, a first PDU or a first PDU set with a sequence number that is greater than that of a second PDU or a second PDU set within a data burst, an application unit, a PDU group, or a PDU set group, and decoding or displaying of the first PDU or the first PDU set depends on decoding or displaying of the second PDU or the second PDU set. In some embodiments, one or more PDUs belonging to a same multi-modality and/or the one or more PDUs that have a relationship are encoded in a same PDU set. In some embodiments, the PDU set dependency indication indicates whether a dependency between PDU sets is considered for a PDU set delivery.

In some embodiments, the PDU set group information includes at least one of following: whether a PDU set group is considered for a PDU set delivery, a delay budget of the PDU set group, an error rate of the PDU set group, or a survival time of the PDU set group. In some embodiments, the PDU set synchronization information includes at least one of following: whether a PDU set synchronization is considered for a PDU set delivery, a delay budget of PDU sets that need synchronization, or a survival time of the PDU sets that need synchronization. In some embodiments, the PDU set group delay budget indicates an upper bound for a time that a depended PDU set may be delayed when a PDU set is transmitted or received, where the depended PDU set includes a data frame that is depended by another data frame, or the PDU set group delay budget indicates an upper bound for a time that two depended PDU sets or more than two PDU sets are transmitted or received, where the two depended PDU sets includes at least two data frames that depend on each other.

In some embodiments, the configuration includes multi-modality Information reporting indication per PDU session, the configuration includes a PDU session identifier (ID), the configuration includes multi-modality information reporting indication per user equipment (UE), and/or the configuration includes a multi-modality information reporting prohibit timer. In some embodiments, the report comprising the multi-modality information includes: a relationship indication between the PDU sessions and/or between the QoS flows, a PDU set group delay budget, a second PDU session ID associated with a first PDU session, an second QoS flow ID associated with a first QoS flow item, an QoS flow list comprising the QoS flows that are associated with each other, or a multi-modality information indication configured per QoS flow.

In some embodiments, the relationship indication between the PDU sessions and/or between the QoS flows is indicated by a global relationship identifier. In some embodiments, a PDU set group or relationship is indicated in the report by at least one of: a global relationship identifier associated with multiple PDU sets of multiple PDU sessions or multiple QoS flows, an explicit associated second PDU set sequence number, an associated second PDU session ID, and/or an associated second QoS flow ID contained in a first PDU set.

A second example wireless communication method includes receiving, by a network device, an indication that a communication device is capable of transmitting a report that includes multi-modality information, where the multi-modality information includes information about packet data unit (PDU) sessions, quality of service (QoS) flows and/or sub QoS flows that are related to each other; transmitting, in response to receiving the indication, a message that includes a configuration; and receiving, in response to transmitting the configuration, the report comprising the multi-modality information.

In some embodiments, the configuration includes multi-modality information reporting indication per PDU session, the configuration includes a PDU session identifier (ID), the configuration includes multi-modality information reporting indication per QoS flow or QoS flow identifier (ID) in a PDU session, and/or the configuration includes a multi-modality information reporting prohibit timer. In some embodiments, the report comprising the multi-modality information includes a QoS flow information that include the QoS flows, each QoS flow comprises at least one of a sub QoS flow list, a PDU set dependency indication, a PDU set group information, a PDU set synchronization information and/or a PDU set group delay budget, the sub QoS flow list includes the sub QoS flows, or the report comprising the multi-modality information includes a Multi-modality information indication configured per sub QoS flow.

In some embodiments, each sub QoS flow includes at least one of a sub QoS flow identifier (ID), a sub QoS flow priority, packet delay budget (PDB), packet error rate (PER), PDU set delay budget (PSDB), or PDU set error rate (PSER). In some embodiments, a first PDU or a first PDU set with a sequence number that is greater than that of a second PDU or a second PDU set within a data burst, an application unit, a PDU group, or a PDU set group. In some embodiments, one or more PDUs belonging to a same multi-modality and/or the one or more PDUs that have a relationship are encoded in a same PDU set. In some embodiments, the PDU set dependency indication indicates whether a dependency between PDU sets is considered for a PDU set delivery. In some embodiments, the PDU set group information includes at least one of following: whether a PDU set group is considered for a PDU set delivery, a delay budget of the PDU set group, an error rate of the PDU set group, or a survival time of the PDU set group.

In some embodiments, the PDU set synchronization information includes at least one of following: whether a PDU set synchronization is considered for a PDU set delivery, a delay budget of PDU sets that need synchronization, or a survival time of the PDU sets that need synchronization. In some embodiments, the PDU set group delay budget indicates an upper bound for a time that a depended PDU set may be delayed when a PDU set is transmitted or received, where the depended PDU set includes a data frame that is depended by another data frame, or the PDU set group delay budget indicates an upper bound for a time that two depended PDU sets or more than two PDU sets are transmitted or received, where the two depended PDU sets includes at least two data frames that depend on each other. In some embodiments, the configuration includes multi-modality Information reporting indication per PDU session, the configuration includes a PDU session identifier (ID), the configuration includes multi-modality information reporting indication per user equipment (UE), and/or the configuration includes a multi-modality information reporting prohibit timer.

In some embodiments, the report comprising the multi-modality information includes: a relationship indication between the PDU sessions and/or between the QoS flows, a PDU set group delay budget, a second PDU session ID associated with a first PDU session, an second QoS flow ID associated with a first QoS flow item, an QoS flow list comprising the QoS flows that are associated with each other, or a multi-modality information indication configured per QoS flow. In some embodiments, the relationship indication between the PDU sessions and/or between the QoS flows is indicated by a global relationship identifier. In some embodiments, a PDU set group or relationship is indicated in the report by at least one of: a global relationship identifier associated with multiple PDU sets of multiple PDU sessions or multiple QoS flows, an explicit associated second PDU set sequence number, an associated second PDU session ID, and/or an associated second QoS flow ID contained in a first PDU set.

A third example wireless communication method includes receiving, by a communication device, a delay budget or a discard timer of a packet data unit (PDU) set group; starting one or more timers that are set to the delay budget or the discard timer upon receiving or transmitting at least one PDU in the PDU set group; and discarding, based on an expiration of the one or more timers, one or more PDU sets of the PDU set group.

In some embodiments, the starting one or more timers includes starting a single timer in response to receiving or transmitting a PDU in the PDU set group, and the discarding is performing in response to an expiration of the single timer. In some embodiments, the starting one or more timers includes starting a timer for each PDU in the PDU set group that is transmitted or received, PDUs in the PDU set group are associated with a plurality of timers, and the discarding is performing in response to an expiration of any one of the plurality of timers for the PDUs in the PDU set group. In some embodiments, the discarding the one or more PDU sets includes discarding all PDUs and/or all PDU sets of the PDU set group in response to the communication device not having received or not having transmitted at least one PDU set from the PDU set group when the one or more timers expires.

A fourth example wireless communication method includes receiving, by a communication device, a delay budget or a discard timer of a packet data unit (PDU) set group; starting a timer that is set to the delay budget or the discard timer upon receiving or transmitting at least one PDU in the PDU set group; and determining a transmission priority of a PDU or a PDU set based on a remaining time of the timer.

In some embodiments, the remaining time indicates a remaining time value of the PDU set group before the one or more PDU sets of the PDU set group is discarded. In some embodiments, the remaining time is determined by one of the following: the remaining timer value of the PDU set group is equal to a value of the delay budget or the discard timer minus a timer value that has already elapsed for a first PDU in the PDU set group, the remaining timer value of the PDU set group is equal to the delay budget or the discard timer minus a maximum timer value already elapsed for PDUs in the PDU set group, or the remaining timer value of the PDU set group is equal to a shortest remaining value of a packet data convergence protocol (PDCP) discard timer in the PDU set group.

In some embodiments, the transmission priority of the PDU or the PDU set is determined by one of the following: the transmission priority has an inverse mathematical relationship with the remaining time; the PDU or the PDU set or the PDU set group with the remaining time less than or equal to a threshold is selected as having a highest priority for transmission, or radio link control (RLC) data PDUs that are pending for retransmission are selected as having a highest priority for transmission, and one or more remaining uplink (UL) resources will be allocated to logical channels based on logical channel prioritization.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example flowchart for multi-modality information reporting.

FIG. 2 shows another example flowchart for multi-modality information reporting.

FIG. 3 shows an example flowchart for multi-modality delay budget usage.

FIG. 4A shows an exemplary flowchart for transmitting a report.

FIG. 4B shows an exemplary flowchart for receiving a report.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7A shows an exemplary flowchart for discarding one or more packet data unit (PDU) sets.

FIG. 7B shows an exemplary flowchart for determining a transmission priority of a PDU.

### DETAILED DESCRIPTION

For extended reality (XR) multi-modality service, some coordination between different media components may be needed for better Quality of Experience (QoE), such as for, e.g., audio and tactile synchronization, visual and tactile synchronization etc., as shown in the following table.

| Media Components | Synchronization Threshold | |
|---|---|---|
| Audio-Tactile | Audio delay budget: | Tactile delay budget: |
| | 50 ms | 25 ms |
| Visual-Tactile | Visual delay budget: | Tactile delay budget: |
| | 15 ms | 50 ms |

For each media component, “delay” may refer to the case where that media component is delayed compared to the other.

Multi-modality Data can describe the input data from different kinds of devices/sensors or the output data to different kinds of destinations (e.g. one or more UEs) that may be required for the same task or application. Multi-modality Data may consists of more than one Single-modality Data, and there may be a strong dependency among each Single-modality Data. Single-modality Data can be seen as one type of data. Different types of data may be grouped together (called a group of packet data units (PDUs), or a group of PDU sets) for a same task.

Synchronization threshold can be a multi-modality synchronization threshold that can be defined as a maximum tolerable temporal separation of the onset of two data burst, one of which is presented to one sense and the other to another sense, such that the accompanying sensory objects are perceived as being synchronous.

If Multi-modality traffic is mapped to a single QoS flow, different QoS configuration for different modality can not be differentiated. If Multi-modality traffic is mapped to multiple QoS flows, how to coordinate handling for multiple QoS flows can be considered, e.g., different QoS flows may be synchronized in the cellular network for good user experience for the XR service. For example, if one QoS flow is delayed or is prioritized over another, the user may experience degraded performance for the second flow and for the experience in general. Usually, the QoS flow information is provided by Core Network (CN), e.g., AMF. But for some cases, UE can also report the QoS flow information to gNB for scheduling the radio resource effectively. To address at least these technical issues, this patent document describes the following technical solutions.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Embodiment 1—Multi-Modality Information Reporting

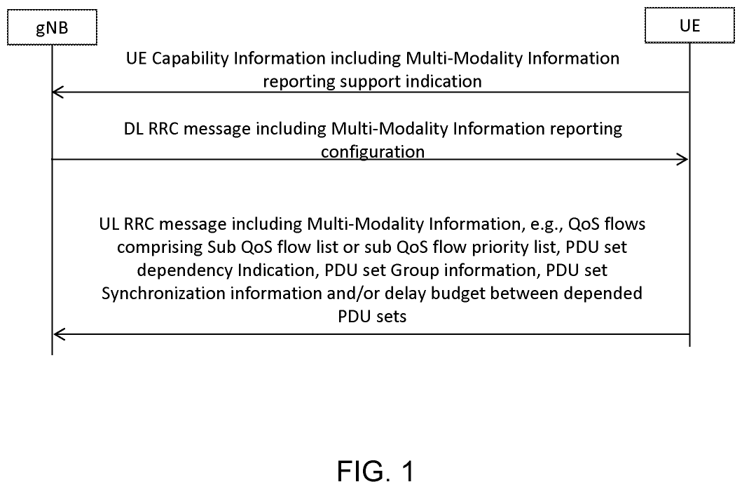

FIG. 1 shows an example flowchart for multi-modality information reporting.
Step 1: UE reports that the UE is capable of supporting Multi-Modality Information reporting. For example, the UE can include a Multi-Modality Information reporting support indication in a UE Capability Information message that the UE transmits to the gNB.
Step 2: gNB configures the Multi-Modality Information reporting information, e.g. including the Multi-Modality Information reporting configuration in DL RRC message, to activate UE to report Multi-Modality Information. The Multi-Modality Information reporting configuration includes at least one of the following: Multi-Modality Information reporting indication per PDU session to indicate whether Multi-Modality Information should be reported for the PDU session; a PDU session ID; Multi-Modality Information reporting indication per QoS flow to indicate whether Multi-Modality Information should be reported for the QoS flow in the PDU session; QoS flow ID in a PDU session; and/or Multi-Modality Information reporting prohibit timer to prohibit UE to send multi-modality information frequently, e.g. Multi-Modality Information reporting prohibit timer is started when UE sends multi-modality information for a PDU session or QoS flow, and the UE is prohibited to send another multi-modality information for the PDU session or QoS flow while the Multi-Modality Information reporting prohibit timer is running.
Step 3: Based on the Multi-Modality Information reporting configuration, UE reports Multi-Modality Information to gNB through UL RRC message (e.g., UEAssistanceInformation). The Multi-Modality Information may describe Multiple Modalities that have strong data frames dependency among each other for a task, e.g. a voice/audio data frame and a video data frame that have a relationship. For example, the Multi-Modality Information may describe a service with a voice/audio data frame and a video data frame that have a relationship.

The Multi-Modality Information may include QoS flows information that includes information indicative of a plurality of QoS flow, where each QoS flow comprises at least one of the: sub QoS flow list that identifies a plurality of sub QoS flows and each modality is mapped to one sub QoS flow, PDU set dependency indication, PDU set group information, PDU set synchronization information, PDU set group delay budget (e.g., delay budget between depended PDU sets). The Multi-Modality Information may include Multi-modality information indication configured per sub QoS flow to indicate whether the Multi-Modality Information can be identified, or whether the reported Multi-Modality Information is still valid.

Each Sub QoS flow includes as least one of: Sub QoS flow ID, Sub QoS flow priority, packet delay budget (PDB), packet error rate (PER), PDU set delay budget (PSDB), or PDU set error rate (PSER), which is used to differentiate different QoS requirement in one QoS flow. With this, PDU Set Sequence Number and/or PDU Sequence Number with dependency can be encoded per QoS flow. For example, the PDU or PDU sets within the sequence number range between two adjacent data burst end indications, application unit end indications, PDU Group end indications or PDU set Group end indications are one data burst, one application unit, one PDU group, or one PDU set group.

In some embodiments, within a data burst, application unit, PDU Group or a PDU set Group, the PDU or PDU set with larger sequence number (e.g., the later one in time domain) depends on the PDU or PDU set with smaller sequence number (e.g. the former one) for decoding or for showing (or displaying) in application layer.

In some embodiments, within a data burst, application unit, PDU Group or a PDU set Group, there is some integrity handling requirement, e.g. if a PDU or PDU set in which is transmitted successfully, the remaining PDU or PDU set in which should be transmitted with higher priority (e.g., should be transmitted within a delay budget configured); if a PDU or PDU set in which is dropped or discarded, the remaining PDU or PDU set in which should also be dropped or discarded.

In some embodiments, the one or more PDUs may belonging to a same Multi-Modality and/or the one or more PDUs that has relationship are encoded in a same PDU set, which are discarded or scheduled based on existing PDU set mechanism.

In some embodiments, the PDU set dependency indication indicates whether dependency between PDU sets should be considered for PDU set delivery. If the PDU set dependency indication is included in the Multi-Modality Information reporting configuration, the PDU set dependency should be considered for delivery, e.g. in-sequence delivery should be performed, and if the former PDU set is lost, the thereafter PDU Set(s) depending on it should not be delivered anymore (e.g. will be discarded)

The PDU set group information may include at least one of the following: whether PDU set group should be considered for PDU set delivery, the delay budget of PDU set group (e.g. the upper bound for the delay that a PDU Set Group may experience for the transfer between the UE and the gNB, e.g. between PDCP entities), the error rate of PDU set group (e.g. the upper bound for the error rate of PDU Set groups that have been processed by the sender of a radio link layer protocol), and/or the survival time of PDU set group (e.g. the time deadline that the PDU set group should be delivered to the receiving side, or the time period that the PDU set group can survive before delivering to the receiving side, otherwise the PDU set group will be discarded).

The PDU set synchronization information may include at least one of the following: whether PDU set synchronization should be considered for PDU set delivery, the delay budget of the PDU sets that need synchronization (e.g. the upper bound for the delay that the PDU Set may experience for the transfer between the UE and the gNB, e.g. between PDCP entities), and/or the survival time of the PDU sets that need synchronization (e.g. the time deadline that the PDU sets should be delivered to the receiving side, or the time period that the PDU sets can survive before delivering to the receiving side, otherwise the PDU sets that need synchronization will be discarded).

The PDU set group delay budget may indicate an upper bound for the time that a depended PDU set may be delayed when a PDU set arrives or transmits, or an upper bound for the time that two depended PDU sets or more than two PDU sets should arrives in or transmits. In some embodiments, a depended PDU set is PDU set that is depended on another PDU set for decoding or displaying, e.g., if a voice frame data depends on a video frame data for decoding or displaying, then the PDU set including a video frame data is a depended PDU set. If the depended PDU set has not arrived or transmitted during the delay budget between depended PDU sets, the other PDU set that depends on it will be useless and should not be transmitted anymore, and may be discarded.

The PDU set dependency can also be PDU set reference. For example, if PDU Set A depends on PDU set B for decoding, PDU set A refers to PDU set B for decoding.

In some embodiments, PDU set A may depend on PDU set B only, in which case, PDU set B is a depended PDU set so that if PDU set A is received, PDU set B should be received within the PDU set group delay budget. In some embodiments, PDU set A may depend on PDU set B and PDU set B may depend on PDU set A, in which case both PDU set A and PDU set B are depended PDU sets so that if either PDU set A or PDU set B is received, the other one should be received within the PDU set group delay budget.

In some embodiments, the Multi-Modality Information in Step 3 of FIG. 1 can also be provided by a core network (CN) (e.g. AMF) to gNB by using UE associated signalling.

### II. Embodiment 2—Another Multi-Modality Information Reporting

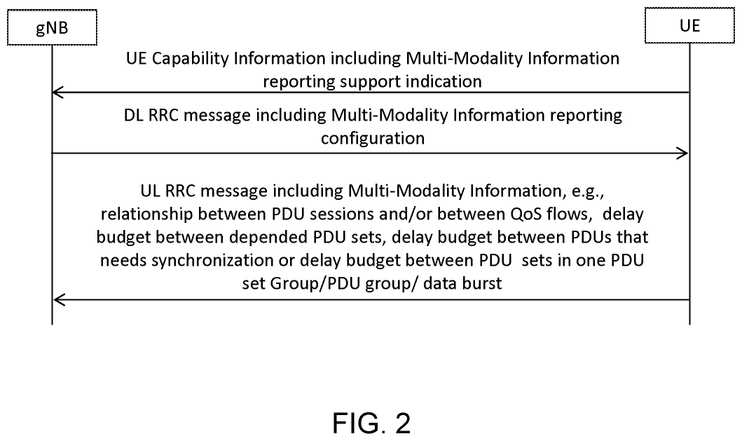

FIG. 2 shows another example flowchart for multi-modality information reporting.
Step 1: This step is the same as Step 1 in FIG. 1.
Step 2: gNB configures the Multi-Modality Information reporting information, e.g., including the Multi-Modality Information reporting configuration in DL RRC message, to activate UE to report Multi-Modality Information.

Wherein the Multi-Modality Information reporting configuration includes at least one of the following: Multi-Modality Information reporting indication per PDU session to indicate whether Multi-Modality Information should be reported for the PDU session; PDU session ID; Multi-Modality Information reporting indication per UE to indicate whether Multi-Modality Information should be reported for the UE; and/or Multi-Modality Information reporting prohibit timer (the same as that in FIG. 1).
Step 3: Based on the Multi-Modality Information reporting configuration, UE reports Multi-Modality Information to gNB through UL RRC message (e.g., UEAssistanceInformation).

Wherein the Multi-Modality Information includes at least one of the following: relationship indication between PDU sessions and/or between QoS flows, PDU set group delay budget (delay budget between depended PDU sets, delay budget between PDUs that needs synchronization or delay budget between PDU sets in one PDU set Group/PDU group/data burst).

The relationship indication between PDU sessions and/or between QoS flows can be indicated by at least one of: a global Relationship identifier (e.g. a PDU session Group identity, a PDU session associated ID, a PDU session synchronization ID, a QoS flow Group identity, a QoS flow associated ID, an/or a QoS flow synchronization ID) associated with multiple PDU sessions or multiple QoS flows (e.g. the multiple PDU sessions or multiple QoS flows with same global Relationship identifier have relationships (e.g. the PDU set in one PDU session or QoS flow may associate the PDU set in another PDU session or QoS flow), an associated second PDU session ID associated with a first PDU session, associated second QoS flow ID associated with a first QoS flow item, an associated QoS flow list that has QoS flows that have relationship or are associated with each other (e.g. included in PDU session), Multi-Modality Information indication configured per QoS flow to indicate whether the Multi-Modality Information can be identified, or whether the reported Multi-Modality Information is still valid.

If included, the PDU set sequence number may be coded across the associated PDU sessions or associated QoS flows, e.g., PDU set in-sequence delivery of different PDU sessions or QoS flows should be performed, and if the former PDU set is lost, the thereafter PDU Set(s) depending on it should not be delivered anymore (e.g., will be discarded). In which case, delay budget between depended PDU sets should also be included associated with the Relationship indication between PDU sessions and/or between QoS flows by Control plain from CN to gNB by Control plain. Wherein the PDU set group (e.g., the PDU sets that needs synchronized transmission) can be identified by: PDU set Group start indication, PDU set Group end indication, PDU set sequence number. E.g. one PDU set group includes PDU sets with continuous PDU set sequence number, which is start from the PDU set with PDU set Group start indication to the next and nearest PDU set with PDU set Group end indication, start from the PDU set with PDU set Group start indication and before the next PDU set with PDU set Group start indication, or start after the last PDU set with PDU set Group end indication to the PDU set with PDU set Group end indication

Another implementation, the PDU set sequence number are coded per QoS flow, and the PDU set group or relationship (e.g., the PDU sets need synchronized transmission) can be indicated in the report by at least one of: a global Relationship identifier (e.g., a PDU set Group identity, a PDU set associated ID, a PDU set synchronization ID) associated with multiple PDU Sets of multiple PDU sessions or multiple QoS flows (e.g. the PDU set with global Relationship identifier in one PDU session or QoS flow may depends on the PDU set with the same global Relationship identifier in another PDU session or QoS flow); explicit associated second PDU set sequence number, associated second PDU session ID and/or associated second QoS flow ID contained in a first PDU set.

The PDU set group delay budget may be, for example, the delay budget between PDU sets in one PDU set Group/PDU group/data burst indicates an upper bound for the time that a depended PDU set in one PDU set Group/PDU group/data burst may be delayed when a PDU set arrives, or an upper bound for the time that two or more of depended PDU sets should arrives in. If at least one of the depended PDU set has not arrived during the delay budget between depended PDU sets, the other PDU set of the depended PDU set will be useless and should not be transmitted anymore, and may be discarded.

In some embodiments, the Multi-Modality Information in Step 3 can also be provided by a core network (CN) (e.g. AMF) to gNB by using UE associated signaling.

The difference between FIG. 1 and FIG. 2 is mainly that:
In FIG. 1, multi-modality information is mapped to multiple sub QoS flow of one QoS flow (e.g., each modality Data flow is mapped to one sub QoS flow), and the PDU set Group (e.g., the PDU sets that needs synchronized transmission) can be identified by: PDU set Group start indication, PDU set Group end indication, PDU set sequence number. E.g. one PDU set group includes PDU sets with continuous PDU set sequence number, which is start from the PDU set with PDU set Group start indication to the next and nearest PDU set with PDU set Group end indication, start from the PDU set with PDU set Group start indication and before the next PDU set with PDU set Group start indication, or start after the last PDU set with PDU set Group end indication to the PDU set with PDU set Group end indication.
In FIG. 2, multi-modality information is mapped to multiple QoS flow of one QoS flow (e.g., each modality Data flow is mapped to one QoS flow). In which case, either PDU set sequence number is coded across multiple QoS flow, and the PDU set group is identified as that in FIG. 1; the PDU set Group (the PDU sets that needs synchronized transmission) can be identified by a global Relationship identifier (e.g., a PDU set Group identity, a PDU set associated ID, a PDU set synchronization ID); one PDU set includes an explicit associated PDU set ID (e.g., PDU set sequence number, PDU session ID and/or QoS flow ID) to show that the two PDU set are associated.

### III. Embodiment 3—Multi-Modality Delay Budget Usage

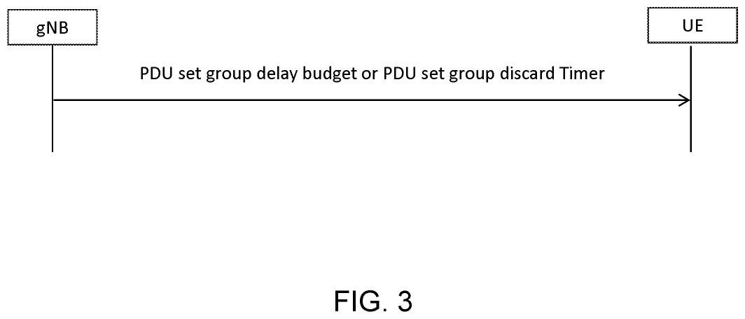

FIG. 3 shows an example flowchart for multi-modality delay budget usage.

Based on the PDU set group delay budget reported by UE or provided from CN, gNB sends the Uu PDU set group delay budget or PDU set group discard Timer to UE.

Based on the Uu PDU set group delay budget or PDU set group discard Timer to UE, UE can decide the timer expiry of PDU set group. For example, when a first PDU in a PDU set group arrives at the UE (e.g., UE PDCP) or is transmitted from the UE, the UE starts a timer (with the upper limit of Uu PDU set group delay budget or PDU set group discard Timer to UE). In this example, when the UE determines that the timer expires, the UE determines that the timer has expired for the PDU set group. In another example, the UE starts the timer for each PDU when it arrives at the UE (e.g., UE PDCP) or is transmitted from the UE. In this another example, if the UE determines that the timer for any PDU in the PDU set group expires, the UE determines that all timers for all the PDU in the PDU set group have expired or the timer of PDU set group has expired.

Based on timer expiry of PDU set group, UE can decide to discard some invalid PDU set of a PDU set group. E.g. when a first PDU in a PDU set group arrives at the UE (e.g., UE PDCP) or is transmitted from the UE, the UE starts a timer (with the upper limit of Uu PDU set group delay budget or PDU set group discard Timer to UE), if at least one of the PDU set in the PDU set group has not arrived and/or has not arrived been transmitted successfully when the timer expires, the UE discards all the PDUs and/or PDU sets in the PDU set group; or UE starts the timer for each PDU when it arrives at the UE (e.g., UE PDCP) or transmitted from the UE, if the timer for any PDU in the PDU set group expires, it seems that all timers for all the PDU in the PDU set group expires or the timer of PDU set group expires, if at least one of the PDU set in the PDU set group has not arrived and/or has not arrived been transmitted successfully when the timer expires, the UE discards all the PDUs and/or PDU sets in the PDU set group.

If both PDU (or PDU set) discardTimer and the PDU set group discard Timer are configured to UE, the PDU set will be discarded if any one of them expires, which ever earlier. E.g. if the PDU (or PDU set) discardTimer expires, the PDU (or PDU set) is discarded; if the PDU set group discardTimer expires, all the PDU (or PDU set) in the PDU set group are discarded.

Based on remaining time of PDU set group, UE can decide the PDU set transmission priority. Wherein the remaining time indicate the remaining timer value of PDU set group before it expires. It can be calculated based on one of:

The remaining timer value of PDU set group=the value of Uu PDU set group delay budget or PDU set group discard Timer configured−the timer value of the first PDU in a PDU set group already elapsed,

The remaining timer value of PDU set group=the value of Uu PDU set group delay budget or PDU set group discard Timer configured−the maximal timer value of the PDUs in a PDU set group already elapsed, or

The remaining timer value of PDU set group=the shortest remaining value of PDCP discardTimer in the PDU set group.

One implementation: the smaller that the remaining time of PDU set group is, the higher the priority that the PDUs of the PDU set group is transmitted. In one implementation, the remaining time of PDU set group is used in Logical Channel Prioritization determination. For example, the Logical Channel priority is calculated based on the PBR*1/remaining time and buffers served currently, which should be guaranteed that: the larger the PBR*1/remaining time, the higher Logical Channel Prioritization is. Before performing this, network should indicate that remainingTime is used for Logical channel prioritization. For example:

The following UE variable is used for the Logical channel prioritization procedure:

| | |
|---|---|
| - | Bj which is maintained for each logical channel j. |

The MAC entity shall initialize Bj of the logical channel to zero when the

logical channel is established.

For each logical channel j, the MAC entity shall:

If network indicates that remainingTime is used for Logical channel

prioritization:

| | |
|---|---|
| 1> | increment Bj by the product PBR × T × 1/remainingTime before every instance of |
| | the LCP procedure, where T is the time elapsed since Bj was last incremented, and |
| | remaining time is the remining time before the PDU set is discarded for timer |
| | expires; |
| 1> | if the value of Bj is greater than the bucket size (i.e. PBR × BSD): |

2>set Bj to the bucket size.

else:

| | |
|---|---|
| 1> | increment Bj by the product PBR × T before every instance of the LCP procedure, |
| | where T is the time elapsed since Bj was last incremented; |
| | 1>if the value of Bj is greater than the bucket size (i.e. PBR × BSD): |

2>set Bj to the bucket size.

| | The MAC entity shall, when a new transmission is performed: |
|---|---|
| 1> | allocate resources to the logical channels as follows: |

| | |
|---|---|
| 2> | logical channels selected for the UL grant with Bj > 0 are allocated resources |
| | in a decreasing priority order. If the PBR of a logical channel is set to |
| | infinity, the MAC entity shall allocate resources for all the data that is |
| | available for transmission on the logical channel before meeting the PBR of |
| | the lower priority logical channel(s); |
| 2> | decrement Bj by the total size of MAC SDUs served to logical channel j |
| | above; |
| 2> | if any resources remain, all the logical channels selected are served in a strict |
| | decreasing priority order (regardless of the value of Bj) until either the data |
| | for that logical channel or the UL grant is exhausted, whichever comes first. |
| | Logical channels configured with equal priority should be served equally. |

Wherein the

| | |
|---|---|
| - | PBR is prioritisedBitRate which sets the Prioritized Bit Rate ; |
| - | BSD is bucketSizeDuration which sets the Bucket Size Duration. |

Whether remainingTime is used for Logical channel prioritization determination is configured by network in DL RRC message. It can be configured per logical channel (e.g. the indication is included in logical channel configuration), per DRB (e.g. the indication is included in DRB configuration or PDCP configuration) or per UE.

And whether gNB configures that remainingTime is used for Logical channel prioritization determination can be based on a UE capability report (e.g. to indicate supporting that remainingTime is used for Logical channel prioritization or supporting that multi-modality information reporting).

In another implementation, the PDU/PDU set/PDU set group with remaining time less than or equal to a threshold (higher priority scheduling threshold) will be selected as the highest priority for transmission; or the PDU/PDU set/PDU set group with remaining time less than or equal to a threshold will be selected for transmission firstly, and the remaining UL resource will be allocated to the logical channels based on logical channel Prioritization (e.g. BPR, BSD and elapsed time, etc.,). Where the threshold is configured from gNB to UE, by RRC or by MAC CE, per logical channel, per DRB or per UE. For example:

The following UE variable is used for the Logical channel prioritization procedure:

| | |
|---|---|
| - | Bj which is maintained for each logical channel j. |

The MAC entity shall initialize Bj of the logical channel to zero when the

logical channel is established.

For each logical channel j, the MAC entity shall:

1> increment Bj by the product PBR × T before every instance of the LCP

procedure, where T is the time elapsed since Bj was last incremented;

| | |
|---|---|
| 1> | if the value of Bj is greater than the bucket size (i.e. PBR × BSD): |

| | |
|---|---|
| 2> | set Bj to the bucket size. |

| | |
|---|---|
| | The MAC entity shall, when a new transmission is performed: |
| 1> | if a remaining time threshold is configured [for a logical channel], and there is |
| | PDU/PDU set or PDU set group with remaining time less than or equal to a |
| | threshold, the MAC entity shall allocate resources for all the data(PDU/PDUset |
| | or PDUset group) that the remaining time is less than or equal to the threshold |
| | for transmission on the logical channel. |
| 1> | if there is resources available, allocate resources to the logical channels as |
| | follows: |

| | |
|---|---|
| 2> | logical channels selected for the UL grant with Bj > 0 are allocated resources |
| | in a decreasing priority order. If the PBR of a logical channel is set to |
| | infinity, the MAC entity shall allocate resources for all the data that is |
| | available for transmission on the logical channel before meeting the PBR of |
| | the lower priority logical channel(s); |
| 2> | decrement Bj by the total size of MAC SDUs served to logical channel j |
| | above; |
| 2> | if any resources remain, all the logical channels selected are served in a strict |
| | decreasing priority order (regardless of the value of Bj) until either the data |
| | for that logical channel or the UL grant is exhausted, whichever comes first. |
| | Logical channels configured with equal priority should be served equally. |

Wherein the

| | |
|---|---|
| - | PBR is prioritisedBitRate which sets the Prioritized Bit Rate ; |
| - | BSD is bucketSizeDuration which sets the Bucket Size Duration. |

If both PDU (or PDU set) discardTimer and the PDU set group discard Timer are configured to UE, the remaining time used for Logical Channel Prioritization determination is the shortest of PDU (or PDU set) discard remaining time and PDU set group discard remaining time.

Yet another implementation: RLC data PDUs that are pending for retransmission (RLC AM) are selected as the highest priority for transmission, e.g. be selected for transmission firstly, and the remaining UL resource will be allocated to the logical channels based on logical channel Prioritization (e.g. BPR, BSD and elapsed time, etc). To perform this by UE, network should indicate that RLC retransmission PDU should be scheduled with higher priority. For example:

The following UE variable is used for the Logical channel prioritization procedure:

| | |
|---|---|
| - | Bj which is maintained for each logical channel j. |

The MAC entity shall initialize Bj of the logical channel to zero when the

logical channel is established.

For each logical channel j, the MAC entity shall:

1> increment Bj by the product PBR × T before every instance of the LCP

procedure, where T is the time elapsed since Bj was last incremented;

| | |
|---|---|
| 1> | if the value of Bj is greater than the bucket size (i.e. PBR × BSD): |

| | |
|---|---|
| 2> | set Bj to the bucket size. |

| | |
|---|---|
| | The MAC entity shall, when a new transmission is performed: |
| 1> | if network indicates that RLC retransmission PDU is scheduled with higher |
| | priority, the MAC entity shall allocate resources for all the RLC data PDUs that |
| | are pending for retransmission firstly. |
| 1> | if there is resources aavilable, allocate resources to the logical channels as |
| | follows: |

| | |
|---|---|
| 2> | logical channels selected for the UL grant with Bj > 0 are allocated resources |
| | in a decreasing priority order. If the PBR of a logical channel is set to |
| | infinity, the MAC entity shall allocate resources for all the data that is |
| | available for transmission on the logical channel before meeting the PBR of |
| | the lower priority logical channel(s); |
| 2> | decrement Bj by the total size of MAC SDUs served to logical channel j |
| | above; |
| 2> | if any resources remain, all the logical channels selected are served in a strict |
| | decreasing priority order (regardless of the value of Bj) until either the data |
| | for that logical channel or the UL grant is exhausted, whichever comes first. |
| | Logical channels configured with equal priority should be served equally. |

Wherein the

| | |
|---|---|
| - | PBR is prioritisedBitRate which sets the Prioritized Bit Rate ; |
| - | BSD is bucketSizeDuration which sets the Bucket Size Duration. |

If both PDU (or PDU set) discardTimer and the PDU set group discard Timer are configured to UE, the remaining time used for Logical Channel Prioritization determination is the shortest of PDU (or PDU set) discard remaining time and PDU set group discard remaining time.

Before gNB configure the higher priority scheduling threshold, indication that remainingTime is used for Logical channel prioritization, and/or indication that RLC retransmission PDU may be scheduled with higher priority, UE should report the UE's capability on whether supporting it. gNB can configure the related parameter only if UE supports the related feature.

### IV. Embodiment 4—Multi-Modality Relationship Usage

The multi-modality relationship can be used for gNB to mapping the QoS flow to DRB or logical channel. E.g. the QoS flows for multi-modality are mapped to the same DRB or logical channel, or mapped to logical channels with same logical channel priority.

The multi-modality relationship can be used to decide encoded range of PDU set group identity. E.g. the PDU set group identity is valid only in the QoS flow group and/or PDU session Group (the PDU sets with same valid PDU set group identity have relationship and should be synchronized transmission)

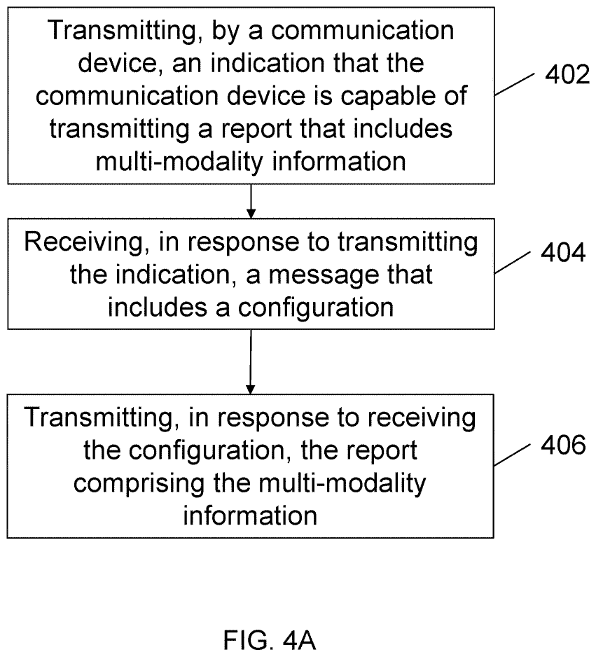

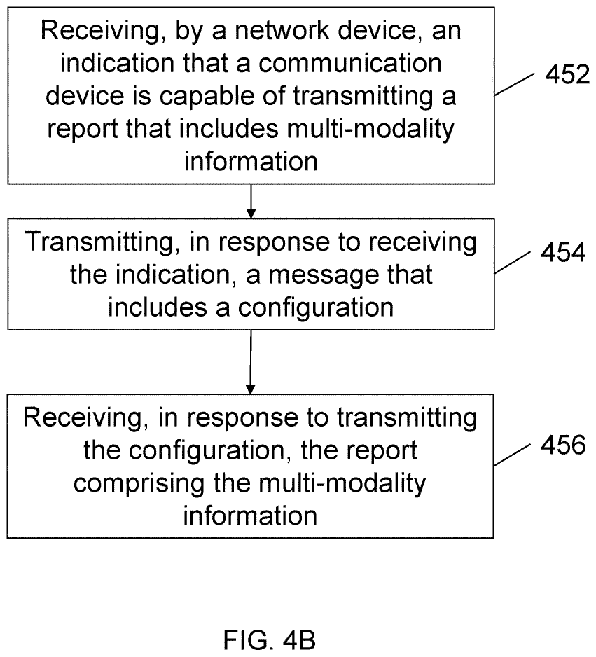

FIG. 4A shows an exemplary flowchart for transmitting a report. Operation 402 includes transmitting, by a communication device, an indication that the communication device is capable of transmitting a report that includes multi-modality information, where the multi-modality information includes information about packet data unit (PDU) sessions, quality of service (QoS) flows and/or sub QoS flows that are related to each other. Operation 404 includes receiving, in response to transmitting the indication, a message that includes a configuration. Operation 406 includes transmitting, in response to receiving the configuration, the report comprising the multi-modality information.

In some embodiments, the configuration includes multi-modality information reporting indication per PDU session, the configuration includes a PDU session identifier (ID), the configuration includes multi-modality information reporting indication per QoS flow or QoS flow identifier (ID) in a PDU session, and/or the configuration includes a multi-modality information reporting prohibit timer. In some embodiments, the report comprising the multi-modality information includes a QoS flow information that include the QoS flows, each QoS flow comprises at least one of a sub QoS flow list, a PDU set dependency indication, a PDU set group information, a PDU set synchronization information and/or a PDU set group delay budget, the sub QoS flow list includes the sub QoS flows, or the report comprising the multi-modality information includes a Multi-modality information indication configured per sub QoS flow.

In some embodiments, each sub QoS flow includes at least one of a sub QoS flow identifier (ID), a sub QoS flow priority, packet delay budget (PDB), packet error rate (PER), PDU set delay budget (PSDB), or PDU set error rate (PSER). In some embodiments, a first PDU or a first PDU set with a sequence number that is greater than that of a second PDU or a second PDU set within a data burst, an application unit, a PDU group, or a PDU set group, and decoding or displaying of the first PDU or the first PDU set depends on decoding or displaying of the second PDU or the second PDU set. In some embodiments, one or more PDUs belonging to a same multi-modality and/or the one or more PDUs that have a relationship are encoded in a same PDU set. In some embodiments, the PDU set dependency indication indicates whether a dependency between PDU sets is considered for a PDU set delivery.

In some embodiments, the PDU set group information includes at least one of following: whether a PDU set group is considered for a PDU set delivery, a delay budget of the PDU set group, an error rate of the PDU set group, or a survival time of the PDU set group. In some embodiments, the PDU set synchronization information includes at least one of following: whether a PDU set synchronization is considered for a PDU set delivery, a delay budget of PDU sets that need synchronization, or a survival time of the PDU sets that need synchronization. In some embodiments, the PDU set group delay budget indicates an upper bound for a time that a depended PDU set may be delayed when a PDU set is transmitted or received, where the depended PDU set includes a data frame that is depended by (or on) another data frame, or the PDU set group delay budget indicates an upper bound for a time that two depended PDU sets or more than two PDU sets are transmitted or received, where the two depended PDU sets includes at least two data frames that depend on each other.

In some embodiments, the configuration includes multi-modality Information reporting indication per PDU session, the configuration includes a PDU session identifier (ID), the configuration includes multi-modality information reporting indication per user equipment (UE), and/or the configuration includes a multi-modality information reporting prohibit timer. In some embodiments, the report comprising the multi-modality information includes: a relationship indication between the PDU sessions and/or between the QoS flows, a PDU set group delay budget, a second PDU session ID associated with a first PDU session, an second QoS flow ID associated with a first QoS flow item, an QoS flow list comprising the QoS flows that are associated with each other, or a multi-modality information indication configured per QoS flow.

In some embodiments, the relationship indication between the PDU sessions and/or between the QoS flows is indicated by a global relationship identifier. In some embodiments, a PDU set group or relationship is indicated in the report by at least one of: a global relationship identifier associated with multiple PDU sets of multiple PDU sessions or multiple QoS flows, an explicit associated second PDU set sequence number, an associated second PDU session ID, and/or an associated second QoS flow ID contained in a first PDU set.

FIG. 4B shows an exemplary flowchart for receiving a report. Operation 452 includes receiving, by a network device, an indication that a communication device is capable of transmitting a report that includes multi-modality information, where the multi-modality information includes information about packet data unit (PDU) sessions, quality of service (QoS) flows and/or sub QoS flows that are related to each other. Operation 454 includes transmitting, in response to receiving the indication, a message that includes a configuration. Operation 456 includes receiving, in response to transmitting the configuration, the report comprising the multi-modality information.

In some embodiments, the configuration includes multi-modality information reporting indication per PDU session, the configuration includes a PDU session identifier (ID), the configuration includes multi-modality information reporting indication per QoS flow or QoS flow identifier (ID) in a PDU session, and/or the configuration includes a multi-modality information reporting prohibit timer. In some embodiments, the report comprising the multi-modality information includes a QoS flow information that include the QoS flows, each QoS flow comprises at least one of a sub QoS flow list, a PDU set dependency indication, a PDU set group information, a PDU set synchronization information and/or a PDU set group delay budget, the sub QoS flow list includes the sub QoS flows, or the report comprising the multi-modality information includes a Multi-modality information indication configured per sub QoS flow.

In some embodiments, each sub QoS flow includes at least one of a sub QoS flow identifier (ID), a sub QoS flow priority, packet delay budget (PDB), packet error rate (PER), PDU set delay budget (PSDB), or PDU set error rate (PSER). In some embodiments, a first PDU or a first PDU set with a sequence number that is greater than that of a second PDU or a second PDU set within a data burst, an application unit, a PDU group, or a PDU set group. In some embodiments, one or more PDUs belonging to a same multi-modality and/or the one or more PDUs that have a relationship are encoded in a same PDU set. In some embodiments, the PDU set dependency indication indicates whether a dependency between PDU sets is considered for a PDU set delivery. In some embodiments, the PDU set group information includes at least one of following: whether a PDU set group is considered for a PDU set delivery, a delay budget of the PDU set group, an error rate of the PDU set group, or a survival time of the PDU set group.

In some embodiments, the PDU set synchronization information includes at least one of following: whether a PDU set synchronization is considered for a PDU set delivery, a delay budget of PDU sets that need synchronization, or a survival time of the PDU sets that need synchronization. In some embodiments, the PDU set group delay budget indicates an upper bound for a time that a depended PDU set may be delayed when a PDU set is transmitted or received, where the depended PDU set includes a data frame that is depended by (or on) another data frame, or the PDU set group delay budget indicates an upper bound for a time that two depended PDU sets or more than two PDU sets are transmitted or received, where the two depended PDU sets includes at least two data frames that depend on each other. In some embodiments, the configuration includes multi-modality Information reporting indication per PDU session, the configuration includes a PDU session identifier (ID), the configuration includes multi-modality information reporting indication per user equipment (UE), and/or the configuration includes a multi-modality information reporting prohibit timer.

In some embodiments, the report comprising the multi-modality information includes: a relationship indication between the PDU sessions and/or between the QoS flows, a PDU set group delay budget, a second PDU session ID associated with a first PDU session, an second QoS flow ID associated with a first QoS flow item, an QoS flow list comprising the QoS flows that are associated with each other, or a multi-modality information indication configured per QoS flow. In some embodiments, the relationship indication between the PDU sessions and/or between the QoS flows is indicated by a global relationship identifier. In some embodiments, a PDU set group or relationship is indicated in the report by at least one of: a global relationship identifier associated with multiple PDU sets of multiple PDU sessions or multiple QoS flows, an explicit associated second PDU set sequence number, an associated second PDU session ID, and/or an associated second QoS flow ID contained in a first PDU set.

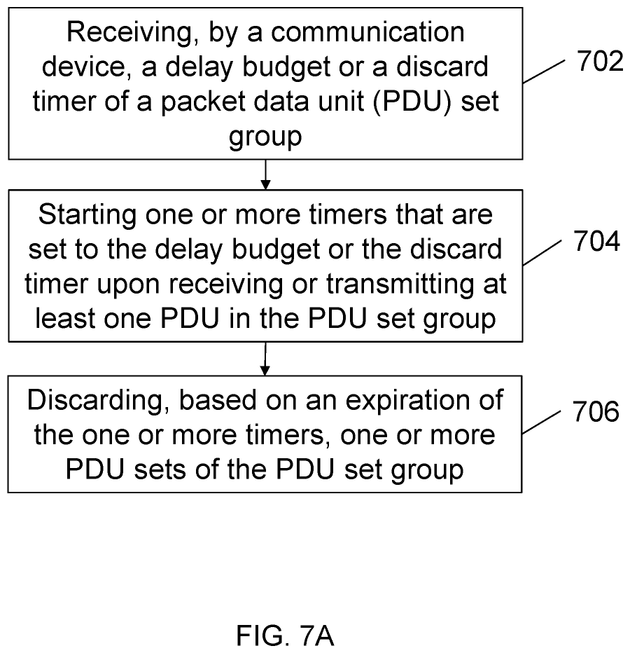

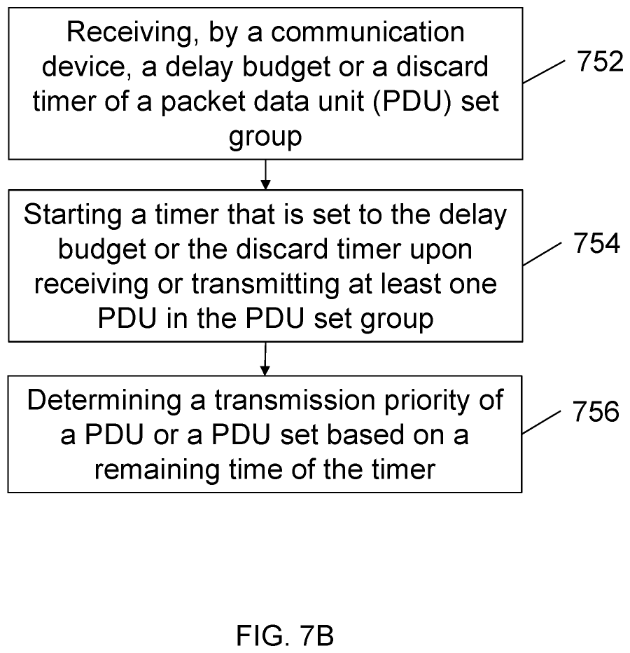

FIG. 7A shows an exemplary flowchart for discarding one or more PDU sets. Operation 702 includes receiving, by a communication device, a delay budget or a discard timer of a packet data unit (PDU) set group. Operation 704 includes starting one or more timers that are set to the delay budget or the discard timer upon receiving or transmitting at least one PDU in the PDU set group. Operation 706 includes discarding, based on an expiration of the one or more timers, one or more PDU sets of the PDU set group.

In some embodiments, the starting one or more timers includes starting a single timer in response to receiving or transmitting a PDU in the PDU set group, and the discarding is performing in response to an expiration of the single timer. In some embodiments, the starting one or more timers includes starting a timer for each PDU in the PDU set group that is transmitted or received, PDUs in the PDU set group are associated with a plurality of timers, and the discarding is performing in response to an expiration of any one of the plurality of timers for the PDUs in the PDU set group. In some embodiments, the discarding the one or more PDU sets includes discarding all PDUs and/or all PDU sets of the PDU set group in response to the communication device not having received or not having transmitted at least one PDU set from the PDU set group when the one or more timers expires.

FIG. 7B shows an exemplary flowchart for determining a transmission priority of a PDU. Operation 752 includes receiving, by a communication device, a delay budget or a discard timer of a packet data unit (PDU) set group. Operation 754 includes starting a timer that is set to the delay budget or the discard timer upon receiving or transmitting at least one PDU in the PDU set group. Operation 756 includes determining a transmission priority of a PDU or a PDU set based on a remaining time of the timer.

In some embodiments, the remaining time indicates a remaining time value of the PDU set group before the one or more PDU sets of the PDU set group is discarded. In some embodiments, the remaining time is determined by one of the following: the remaining timer value of the PDU set group is equal to a value of the delay budget or the discard timer minus a timer value that has already elapsed for a first PDU in the PDU set group, the remaining timer value of the PDU set group is equal to the delay budget or the discard timer minus a maximum timer value already elapsed for PDUs in the PDU set group, or the remaining timer value of the PDU set group is equal to a shortest remaining value of a packet data convergence protocol (PDCP) discard timer in the PDU set group.

In some embodiments, the transmission priority of the PDU or the PDU set is determined by one of the following: the transmission priority has an inverse mathematical relationship with the remaining time; the PDU or the PDU set or the PDU set group with the remaining time less than or equal to a threshold is selected as having a highest priority for transmission, or radio link control (RLC) data PDUs that are pending for retransmission are selected as having a highest priority for transmission, and one or more remaining uplink (UL) resources will be allocated to logical channels based on logical channel prioritization.

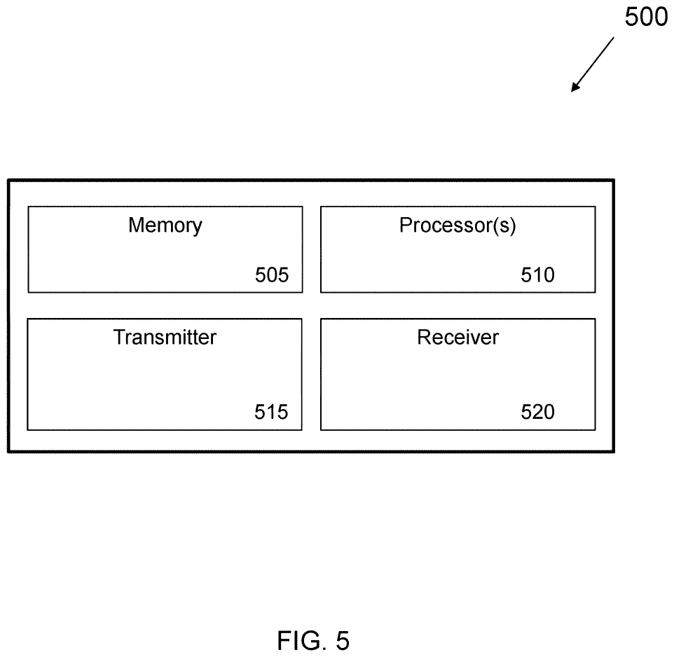

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4B and 6 to 7B in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

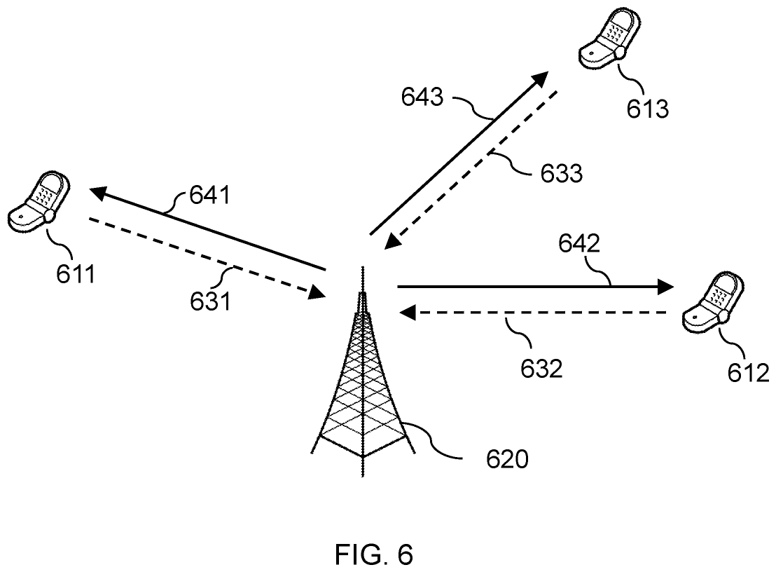

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
transmitting, by a communication device, an indication that the communication device is capable of transmitting a report that includes multi-modality information,
wherein the multi-modality information includes information about packet data unit (PDU) sessions, quality of service (QoS) flows and/or sub QoS flows that are related to each other;
receiving, in response to transmitting the indication, a message that includes a configuration; and
transmitting, in response to receiving the configuration, the report comprising the multi-modality information.

2. The method of claim 1,
wherein the configuration includes multi-modality information reporting indication per PDU session,
wherein the configuration includes a PDU session identifier (ID),
wherein the configuration includes multi-modality information reporting indication per QoS flow or QoS flow identifier (ID) in a PDU session, and/or
wherein the configuration includes a multi-modality information reporting prohibit timer.

3. The method of claim 1,
wherein the report comprising the multi-modality information includes a QoS flow information that include the QoS flows,
wherein each QoS flow comprises at least one of a sub QoS flow list, a PDU set dependency indication, a PDU set group information, a PDU set synchronization information and/or a PDU set group delay budget,
wherein the sub QoS flow list includes the sub QoS flows, or
wherein the report comprising the multi-modality information includes a Multi-modality information indication configured per sub QoS flow.

4. The method of claim 3, wherein each sub QoS flow includes at least one of a sub QoS flow identifier (ID), a sub QoS flow priority, packet delay budget (PDB), packet error rate (PER), PDU set delay budget (PSDB), or PDU set error rate (PSER).

5. The method of claim 3,
wherein a first PDU or a first PDU set with a sequence number that is greater than that of a second PDU or a second PDU set within a data burst, an application unit, a PDU group, or a PDU set group, and
wherein decoding or displaying of the first PDU or the first PDU set depends on decoding or displaying of the second PDU or the second PDU set.

6. The method of claim 3, wherein one or more PDUs belonging to a same multi-modality and/or the one or more PDUs that have a relationship are encoded in a same PDU set.

7. The method of claim 3, wherein the PDU set group information includes at least one of following: whether a PDU set group is considered for a PDU set delivery, a delay budget of the PDU set group, an error rate of the PDU set group, or a survival time of the PDU set group.

8. The method of claim 3, wherein the PDU set synchronization information includes at least one of following: whether a PDU set synchronization is considered for a PDU set delivery, a delay budget of PDU sets that need synchronization, or a survival time of the PDU sets that need synchronization.

9. The method of claim 3,
wherein the PDU set group delay budget indicates an upper bound for a time that a depended PDU set may be delayed when a PDU set is transmitted or received, wherein the depended PDU set includes a data frame that is depended by another data frame, or
wherein the PDU set group delay budget indicates an upper bound for a time that two depended PDU sets or more than two PDU sets are transmitted or received, wherein the two depended PDU sets includes at least two data frames that depend on each other.

10. The method of claim 1,
wherein the configuration includes multi-modality Information reporting indication per PDU session,
wherein the configuration includes a PDU session identifier (ID),
wherein the configuration includes multi-modality information reporting indication per user equipment (UE), and/or
wherein the configuration includes a multi-modality information reporting prohibit timer.

11. The method of claim 1,
wherein the report comprising the multi-modality information includes:
a relationship indication between the PDU sessions and/or between the QoS flows,
a PDU set group delay budget,
a second PDU session ID associated with a first PDU session,
an second QoS flow ID associated with a first QoS flow item,
an QoS flow list comprising the QoS flows that are associated with each other, or
a multi-modality information indication configured per QoS flow.

12. A wireless communication method, comprising:
receiving, by a communication device, a delay budget or a discard timer of a packet data unit (PDU) set group;
starting one or more timers that are set to the delay budget or the discard timer upon receiving or transmitting at least one PDU in the PDU set group; and
discarding, based on an expiration of the one or more timers, one or more PDU sets of the PDU set group.

13. The method of claim 12,
wherein the starting one or more timers includes starting a single timer in response to receiving or transmitting a PDU in the PDU set group, and
wherein the discarding is performing in response to an expiration of the single timer.

14. The method of claim 12,
wherein the starting one or more timers includes starting a timer for each PDU in the PDU set group that is transmitted or received,
wherein PDUs in the PDU set group are associated with a plurality of timers, and
wherein the discarding is performing in response to an expiration of any one of the plurality of timers for the PDUs in the PDU set group.

15. The method of claim 12, the discarding the one or more PDU sets includes discarding all PDUs and/or all PDU sets of the PDU set group in response to the communication device not having received or not having transmitted at least one PDU set from the PDU set group when the one or more timers expires.

16. A wireless communication method, comprising:
receiving, by a communication device, a delay budget or a discard timer of a packet data unit (PDU) set group;
starting a timer that is set to the delay budget or the discard timer upon receiving or transmitting at least one PDU in the PDU set group; and
determining a transmission priority of a PDU or a PDU set based on a remaining time of the timer.

17. The method of claim 16, wherein the remaining time indicates a remaining time value of the PDU set group before one or more PDU sets of the PDU set group is discarded.

18. The method of claim 16, wherein the remaining time is determined by one of:
a remaining timer value of the PDU set group is equal to a value of the delay budget or the discard timer minus a timer value that has already elapsed for a first PDU in the PDU set group,
the remaining timer value of the PDU set group is equal to the delay budget or the discard timer minus a maximum timer value already elapsed for PDUs in the PDU set group, or
the remaining timer value of the PDU set group is equal to a shortest remaining value of a packet data convergence protocol (PDCP) discard timer in the PDU set group.

19. The method of claim 16, wherein the transmission priority of the PDU or the PDU set is determined by one of:
the transmission priority has an inverse mathematical relationship with the remaining time;
the PDU or the PDU set or the PDU set group with the remaining time less than or equal to a threshold is selected as having a highest priority for transmission, or
radio link control (RLC) data PDUs that are pending for retransmission are selected as having a highest priority for transmission, and one or more remaining uplink (UL) resources will be allocated to logical channels based on logical channel prioritization.

20. An apparatus for wireless communication comprising at least one processor, configured to cause the apparatus to implement the method recited in claim 1.
